(19) United States
(12) Patent Application Publication
(10) Pub. No.: US 2024/0009766 A1
(43) Pub. Date: Jan. 11, 2024

(54) Coordinated Scanning and Power Control of Laser for Forming Structures in Ophthalmic Lenses

(71) Applicant: Clerio Vision, Inc., Rochester, NY (US)

(72) Inventors: Sam Butler, Rochester, NY (US); Michael Claus, Rochester, NY (US); Jonathan Ellis, Tucson, AZ (US)

(73) Assignee: Clerio Vision, Inc., Rochester, NY (US)

(21) Appl. No.: 18/472,885

(22) Filed: Sep. 22, 2023

Related U.S. Application Data
(63) Continuation of application No. PCT/US2022/020549, filed on Mar. 16, 2022.
(60) Provisional application No. 63/164,752, filed on Mar. 23, 2021.

(51) Int. Cl. B23K 26/082; B23K 26/06; B23K 26/08; B23K 37/04

(52) U.S. Cl. CPC B23K 26/082; B23K 26/0626; B23K 26/083; B23K 37/04

(57) ABSTRACT

Methods and systems for coordinating pulse powers and focal positions of laser beam pulses used to form a subsurface optical structure. Focal positions for a sequence of laser beam pulses may be stored in a scanning controller configured for controlling operation of a scanning assembly to scan the sequence of laser beam pulses to focal positions in the ophthalmic lens. A memory associated with a power controller may store pulse power data values corresponding to pulse powers for the sequence of laser beam pulses. The power controller can control a pulse power control assembly based on the pulse power data values. Operation of the scanning controller may be synchronized with operation of the power controller during scanning of the sequence of laser beam pulses to the focal positions in the ophthalmic lens via communication of one or more trigger signals between the scanning controller and the power controller.

### CROSS REFERENCES TO RELATED APPLICATIONS

The present application is a Continuation of PCT/US2022/020549 filed Mar. 16, 2022; which claims the benefit of U.S. Provisional Appln No. 63/164,752 filed Mar. 23, 2021, which is herein incorporated by reference in its entirety and for all purposes.

### BACKGROUND

Optical aberrations that degrade visual acuity are common. Optical aberrations are imperfections of the eye that degrade focusing of light onto the retina. Common optical aberrations include lower-order aberrations (e.g., astigmatism, positive defocus (myopia) and negative defocus (hyperopia)) and higher-order aberrations (e.g., spherical aberration, coma, and trefoil).

Existing treatment options for correcting optical aberrations include glasses, contact lenses, and reshaping of the cornea via laser eye surgery. Additionally, intraocular lenses are often implanted to replace native lenses removed during cataract surgery.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Embodiments described herein are directed to systems and methods for forming a subsurface optical structure (e.g., diffractive optical structure and/or non-diffractive optical structure) in an ophthalmic lens. In many embodiments, the subsurface optical structure is formed by focusing femtosecond duration laser pulse beams to a targeted sequence of focal positions in the ophthalmic lens. The systems and methods described herein may be useful in forming a subsurface optical structure(s) in any suitable ophthalmic lens (e.g., intraocular lens, contact lens, cornea, glasses, and/or native lens).

In some embodiments, methods, systems, and devices are described for coordinating power and focal position of a sequence laser beam pulses (or any other suitable energy) within an ophthalmic lens for forming a subsurface optical structure in the ophthalmic lens. The subsurface optical structure can be formed by focusing a sequence of laser beam pulses to focal positions within the ophthalmic lens using a corresponding sequence of laser beam pulse power levels. The subsurface optical structure can have a configuration that may require a large sequence of energy beam pulses (e.g., 10 million, 50 million) to be focused on a corresponding sequence of focal positions within the ophthalmic lens. Additionally, there may be one or more time constraints for forming the subsurface optical structure, such as to achieve high throughput in the case of ophthalmic lenses such as contact lenses, or to alleviate patient discomfort and/or increase safety in the case of an in vivo ophthalmic lens (e.g., in vivo cornea, in vivo implanted intraocular lens). As such, processing challenges associated with controlling focusing of a large sequence of laser beam pulses onto a corresponding sequence of focal positions within the ophthalmic lens within an applicable time constraint can be significant. In some embodiments, a system for forming a subsurface optical structure within an ophthalmic lens includes a scanning-control device and a power-control device. The scanning-control device controls scanning of the sequence of laser beam pulses to the focal positions within the ophthalmic lens. The power-control device controls the power level of each of the sequence of laser beam pulses. In some embodiments, the scanning-control device is separate from the power-control device. Separating the scanning-control computing device from the power-control computing device may be advantageous in that it provides dedicated devices for separately and simultaneously performing the processing tasks necessary for controlling these two aspects (power and focal position of each of the sequence of laser-beam pulses), and may significantly reduce the overall process time, thereby allowing for higher throughput.

Thus, in one aspect, a first method of controlling a laser beam pulse scanning device and a laser beam pulse power-control device to form a subsurface optical structure in an ophthalmic lens includes, storing focal positions for a sequence of laser beam pulses in a scanning controller configured for controlling operation of a scanning assembly to scan the sequence of laser beam pulses to the focal positions in the ophthalmic lens. Pulse power data values corresponding to pulse powers for the sequence of laser beam pulses are stored in a memory accessible by a pulse power controller configured for controlling operation of a power control assembly to control pulse powers of the sequence of laser beam pulses. Operation of the scanning controller is synchronized with operation of the pulse power controller during scanning of the sequence of laser beam pulses to the focal positions in the ophthalmic lens via communication of one or more trigger signals between the scanning controller and the pulse power controller.

In some embodiments, the first method includes loading separate respective control programs into each of the pulse power controller and the scanning controller. For example, the first method can include loading a power control program into the pulse power controller and loading a scanning control program into the scanning controller. The power control program can include instructions for generating power control commands for controlling the power control assembly to control pulse powers of the sequence of laser beam pulses. The scanning control program can include instructions for controlling operation of the scanning assembly to control scanning of the sequence of laser beam pulses to the focal positions in the ophthalmic lens.

The pulse power controller and/or to the scanning controller can have any suitable configuration. For example, the pulse power controller can include a digital input/output (I/O) card.

The scanning assembly can have any suitable configuration. For example, the scanning assembly can include one or more laser galvos and/or a depth of focus mechanism. The one or more laser galvos can be operable to control scanning of the sequence of laser beam pulses to the focal positions in the ophthalmic lens in two directions transverse to a direction of propagation of the sequence of laser beam pulses. The depth of focus mechanism is operable to control scanning of the sequence of laser beam pulses to the focal positions in the ophthalmic lens in the direction of propagation of the sequence of laser beam pulses. In some embodiments, the one or more laser galvos and the depth of focus mechanism are decoupled. In some embodiments, the depth of focus mechanism includes a movable stage on which the ophthalmic lens is disposed, wherein the movable stage is operable to reposition the ophthalmic lens to change a depth of focal position within the ophthalmic lens. In some embodiments, the scanning assembly includes a movable stage on which the ophthalmic lens is disposed, wherein the movable stage is operable to reposition the ophthalmic lens in three-dimensions to scan the sequence of laser beam pulses to the focal positions in the ophthalmic lens.

In some embodiments of the first method, a movable stage can be used in the scanning of the sequence of laser beam pulses to the focal positions in the ophthalmic lens. For example, in some embodiments the ophthalmic lens is disposed on a movable stage. The first method can include controlling positioning of the movable stage during scanning of the sequence of laser beam pulses to the focal positions in the ophthalmic lens. In some embodiments, the first method includes causing a laser pulse source to emit the sequence of laser beam pulses, wherein the laser pulse source is mounted to a movable stage; and controlling positioning of the movable stage during scanning of the sequence of laser beam pulses to the focal positions in the ophthalmic lens. In some embodiments, the first method includes causing a laser pulse source to emit the sequence of laser beam pulses and controlling positioning of a movable stage to scan the sequence of laser beam pulses to the focal positions in the ophthalmic lens.

In some embodiments of the first method, each of the one or more trigger signals includes an instruction to retrieve a new pulse power data value from the memory. The new pulse power data value can corresponds to a pulse power for a laser beam pulse that is next in the sequence of laser beam pulses.

In some embodiments, the first method includes loading a scanning control program into the scanning controller. In some embodiments, the scanning control program controls transmission of the one or more trigger signals.

Any suitable approach can be used to control pulse power. For example, the first method can include controlling an acousto-optic modulator or an electro-optic modulator disposed in between a laser pulse source and the ophthalmic lens to control pulse powers of the sequence of laser beam pulses scanned to the focal positions in the ophthalmic lens.

In some embodiments, the first method includes receiving a definition of the subsurface optical structure. The focal positions and pulse powers of the sequence of laser beam pulses can be defined based on the definition of the subsurface optical structure.

The first method can include determining any suitable scanning parameter for the scanning of the sequence of laser beam pulses to the focal positions in the ophthalmic lens. For example, the first method can include determining one or more scanning speeds for scanning the sequence of laser beam pulses to the focal positions in the ophthalmic lens.

In another aspect, a second method of coordinating control power and scanning of a sequence of laser beam pulses to focal positions in an ophthalmic lens to form a subsurface optical structure in the ophthalmic lens includes loading an ordered list of pulse power data values for the sequence of laser beam pulses on a memory accessible by a power-control computing device. The ordered list of pulse power data values can be indicative of pulse powers for the sequence of laser beam pulses. A scanning control program can be loaded into a scanning-control computing device. The scanning control program can include instructions for generating scanning control commands to control a scanning assembly to direct the sequence of laser beam pulses to the focal positions in the ophthalmic lens. A power control assembly can be controlled by the power-control computing device to cause a first laser beam pulse of the sequence of laser beam pulses to have a first pulse power corresponding to a first pulse power data value of the ordered list of pulse power data values. A scanning assembly can be controlled by the scanning-control computing device to direct the first laser beam pulse to a first focal position of the focal positions in the ophthalmic lens. A first trigger signal can be sent to the power-control computing device. Receipt of the first trigger signal by the power-control computing device can cause the power-control computing device to control the power control assembly to cause a second laser beam pulse of the sequence of laser beam pulses to have a second pulse power corresponding to a second pulse power data value of the ordered list of pulse power data values for the sequence of laser beam pulses. The scanning assembly can be controlled by the scanning-control computing device to direct the second laser beam pulse to a second focal position of the focal positions in the ophthalmic lens.

Each of the power-control computing device and the scanning-control computing device can have any suitable configuration. For example, the power-control computing device can include a digital input/output (I/O) card. The scanning-control computing device can include a programmable scanning controller.

The scanning assembly can have any suitable configuration. For example, the scanning assembly can include one or more laser galvos and/or a depth of focus mechanism. The one or more laser galvos can be operable to control direction for each of the sequence of laser beam pulses in two directions transverse to a direction of propagation of the sequence of laser beam pulses. The depth of focus mechanism is operable to control depth of focus for each of the sequence of laser beam pulses in the direction of propagation of the sequence of laser beam pulses. In some embodiments, the one or more laser galvos and the depth of focus mechanism are decoupled. In some embodiments, the depth of focus mechanism includes a movable stage on which the ophthalmic lens is disposed, wherein the movable stage is operable to reposition the ophthalmic lens to change a depth of focal position within the ophthalmic lens. In some embodiments, the scanning assembly includes a movable stage on which the ophthalmic lens is disposed, wherein the movable stage is operable to reposition the ophthalmic lens in three-dimensions to scan the sequence of laser beam pulses to the focal positions in the ophthalmic lens.

In some embodiments of the second method, the ophthalmic lens is disposed on a movable stage. The second method can include controlling, by the scanning-control computing device, positioning of the movable stage during the scanning of the sequence of laser beam pulses to the focal positions in the ophthalmic lens.

In some embodiments of the second method, a laser pulse source from which the sequence of laser beam pulses is emitted is disposed on a movable stage. The second method can include controlling, by the scanning-control computing device, positioning of the movable stage during the scanning of the sequence of laser beam pulses to the focal positions in the ophthalmic lens.

In some embodiments of the second method, the first trigger signal is generated by the scanning-control computing device. The scanning control program can control transmission of the first trigger signal by the scanning-control computing device.

In some embodiments, the scanning control program specifies when a new pulse power data value of the ordered list of pulse power data values is needed. The second pulse power data value can be next in sequence to the first pulse power data value on the ordered list of pulse power data values.

The power control assembly can have any suitable configuration. For example, the power control assembly can include an acousto-optic modulator and/or an electro-optic modulator.

In some embodiments, the second method includes receiving data defining the subsurface optical structure. The scanning control program can be generated based on the data defining the subsurface optical structure.

In some embodiments, the second method includes sending a second trigger signal to cause the power-control computing device to fetch a third pulse power data value. The power-control computing device can control the power control assembly to cause a laser beam pulse of the sequence of laser beam pulses to have a third pulse power level.

In another aspect, a first system for forming a subsurface optical structure in an ophthalmic lens includes a laser beam pulse source, a power control assembly, a scanning assembly, a power controller, and a scanning controller. The laser beam pulse source is operable to emit a sequence of laser beam pulses. The power control assembly is operable to control a pulse power of each of the sequence of laser beam pulses. The scanning assembly is operable to scan the sequence of laser beam pulses to designated focal positions within the ophthalmic lens. The power controller is configured to control operation of the power control assembly. The power controller stores pulse power data values corresponding to pulse power values for the sequence of laser beam pulses and controls operation of the power control assembly based on the pulse power data values. The scanning controller is configured to control operation of the scanning assembly. The scanning controller stores focal position data defining the designated focal positions for the sequence of laser beam pulses and controls operation of the scanning assembly based on the focal position data. Operation of the scanning assembly and operation of the power control assembly is coordinated via communication of one or more trigger signals between the scanning controller and the power controller. In some embodiments, the power controller includes a digital input/output (I/O) card.

In some embodiments of the first system, the scanning assembly includes a movable stage and a depth of focus mechanism. The movable stage can be configured for mounting of the ophthalmic lens to the movable stage. The scanning controller can control positioning of the movable stage to control position of the ophthalmic lens relative to the depth of focus mechanism during scanning of the sequence of laser beam pulses to the designated focal positions in the ophthalmic lens.

In some embodiments, the first system includes a movable stage. The laser beam pulse source can be disposed on the movable stage. The scanning controller can control positioning of the movable stage and therefore the laser beam pulse source relative to the ophthalmic lens during scanning of the sequence of laser beam pulses to the designated focal positions in the ophthalmic lens.

In some embodiments of the first system, the one or more trigger signals are generated by the scanning controller. The scanning controller can transmit the one or more trigger signals as directed by a scanning control program loaded on the scanning controller.

The power control assembly can have any suitable configuration. For example, in some embodiments of the first system, the power control assembly includes an acousto-optic modulator. In some embodiments of the first system, the power control assembly includes an electro-optic modulator.

In another aspect, a second system for coordinating pulse power and focal positions for a sequence of laser beam pulses for forming a subsurface optical structure in an ophthalmic lens includes a laser beam pulse source, a scanning assembly, a movable stage, a power-control computing device, a power control assembly, and a scanning-control computing device. The laser beam pulse source is operable to emit the sequence of laser beam pulses. The scanning assembly is operable to scan the sequence of laser beam pulses to focal positions within the ophthalmic lens. The power-control computing device includes a power-control memory. The power-control memory is configured to store an ordered list of pulse power data values corresponding to pulse power values for the sequence of laser beam pulses. The power control assembly is operable to control pulse power of each of the sequence of laser beam pulses. The scanning-control computing device includes a scanning-control memory. The scanning-control memory stores a scanning control program that includes instructions for controlling a scanning assembly to direct the sequence of laser beam pulses to the focal positions in the ophthalmic lens. The scanning-control computing device is configured to send a trigger signal to the power-control computing device to cause the power-control computing device to sequentially fetch a pulse power data value from the ordered list of pulse power data values. The power-control computing device is configured to control the power control assembly based on the pulse power data value to control pulse power of the sequence of laser beam pulses. In some embodiments of the second system, the power-control computing device includes a digital input/output (I/O) card. In some embodiments of the second system, the scanning-control computing device includes a programmable scanning controller.

The scanning assembly can have any suitable configuration. For example, in some embodiments of the second system, the scanning assembly includes one or more laser galvos and a depth of focus mechanism. The one or more laser galvos can be operable to control direction of each of the sequence of laser beam pulses in two directions transverse to a direction of propagation of the laser beam pulse. The depth of focus mechanism can be operable to control depth of focus for each of the sequence of laser beam pulses in the direction of propagation of the laser beam pulse.

In some embodiments of the second system, the ophthalmic lens is disposed on the movable stage. The scanning-control computing device can control positioning of the movable stage relative to the laser beam pulse source.

In some embodiments of the second system, the laser beam pulse source is disposed on the movable stage. The scanning-control computing device can control positioning of the movable stage relative to the ophthalmic lens.

In some embodiments of the second system, the trigger signal is generated by the scanning-control computing device. The scanning control program can control transmission of the trigger signal by the scanning-control computing device.

In some embodiments of the second system, the scanning control program specifies when a new pulse power data value is needed. The new pulse power data value can be next in sequence to a current pulse power data value on the ordered list of pulse power data values.

For a fuller understanding of the nature and advantages of the present invention, reference should be made to the ensuing detailed description and accompanying drawings.

### BRIEF DESCRIPTION OF THE DRAWINGS

FIG. 1 is a plan view illustration of an ophthalmic lens that includes subsurface optical structures with enhanced distribution of refractive index variations, in accordance with embodiments.

FIG. 2 is a plan view illustration of a layer of the subsurface optical structures of the ophthalmic lens of FIG. 1.

FIG. 3 illustrates a cross section of an ophthalmic lens including a subsurface optical structure having multiple substructures.

FIGS. 4A-4B illustrate example conceptualizations of an ophthalmic lens that may be defined by a plurality of focal positions within the ophthalmic lens.

FIG. 5 illustrates an example schematic of a system that coordinates pulse power and focal position of laser beam pulses.

FIG. 6 illustrates a table representing a subset of a treatment plan for forming an optical structural on an ophthalmic lens.

FIG. 7 illustrates an example schematic of the system shown in FIG. 5, but from a different viewpoint so as to depict how a central system software module coordinates pulse power and focal position of laser beam pulses.

FIG. 8 illustrates an example method of coordinating pulse power and focal position of laser beam pulses for forming a subsurface optical structure in an ophthalmic lens (e.g., for improving vision in a patient).

FIG. 9 illustrates an example method of controlling a laser beam pulse scanning device and a laser beam pulse power-control device to form a subsurface optical structure in an ophthalmic lens.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

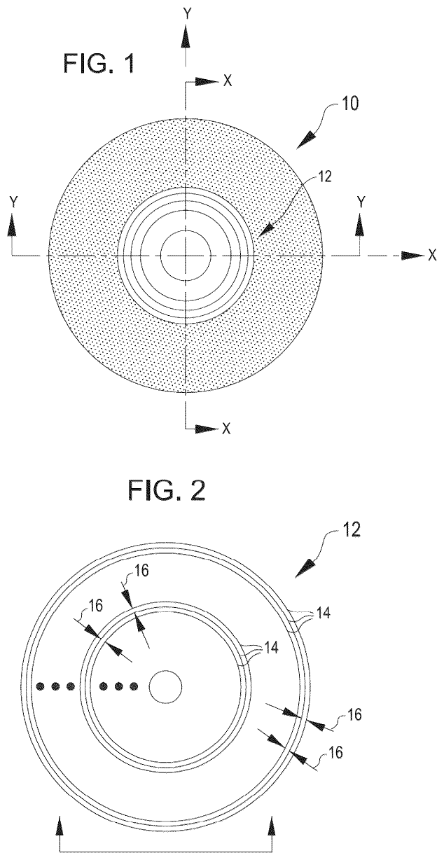

FIG. 1 is a plan view illustration of an ophthalmic lens 10 that includes one or more subsurface optical structures 12 with refractive index variations, in accordance with embodiments. The one or more subsurface structures 12 described herein can be formed in any suitable type of ophthalmic lens including, but not limited to, intraocular lenses, contact lenses, corneas, spectacle lenses, and native lenses (e.g., a human native lens). The one or more subsurface optical structures 12 with refractive index variations can be configured to provide a suitable refractive correction for each of many optical aberrations such as astigmatism, myopia, hyperopia, spherical aberration, coma, trefoil, and other higher order aberrations as well as any suitable combination thereof.

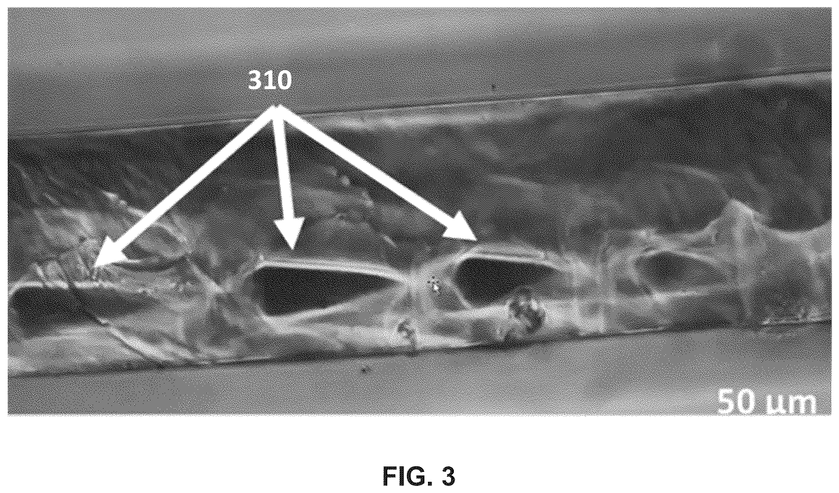

FIG. 2 is a plan view illustration of one of the subsurface optical structures 12 of the ophthalmic lens 10. The illustrated subsurface optical structure 12 includes concentric circular sub-structures 14 separated by intervening line spaces or gaps 16. In FIG. 2, the size of the intervening line spaces 16 is shown much larger than in many actual embodiments. For example, example embodiments described herein have an outer diameter of the concentric circular sub-structures 14 of 3.75 mm and intervening line spaces 16 of 0.25 um, thereby having 7,500 of the concentric circular sub-structures 14 in embodiments where the concentric circular substructures 14 extend to the center of the subsurface optical structure 12. Each of the concentric circular sub-structures 14 can be formed by focusing suitable laser pulses onto contiguous sub-volumes of the ophthalmic lens 10 so as to induce changes in refractive index of the sub-volumes so that each of the sub-volumes has a respective refractive index different from an adjacent portion of the ophthalmic lens 10 that surrounds the sub-structure 14 and is not part of any of the subsurface optical structures 12.

In many embodiments, a refractive index change is defined for each sub-volume of the ophthalmic lens 10 that form the subsurface optical structures 12 so that the resulting subsurface optical structures 12 would provide a desired optical correction when formed within the ophthalmic lens 10. The defined refractive index changes are then used to determine parameters (e.g., average laser pulse power, laser pulse duration) of laser pulses that are focused onto the respective sub-volumes to induce the desired refractive index changes in the sub-volumes of the ophthalmic lens 10.

While the sub-structures 14 of the subsurface optical structures 12 have a circular shape in the illustrated embodiment, the sub-structures 14 can have any suitable shape and distribution of refractive index variations. For example, a single sub-structure 14 having an overlapping spiral shape can be employed. In general, one or more substructures 14 having any suitable shapes can be distributed with intervening spaces so as to provide a desired directing of light incident on the subsurface optical structures 12. More information about subsurface optical structures and forming such structures may be found in U.S. Provisional Application No. 63/001,993, which is incorporated herein by reference in its entirety for all purposes.

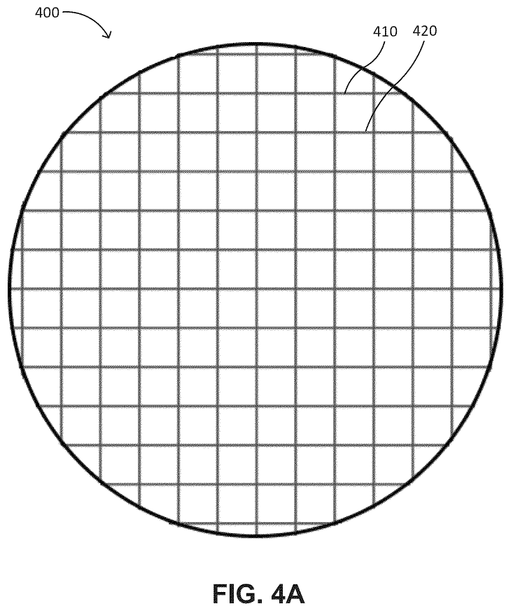

FIG. 3 illustrates a cross section of an ophthalmic lens including a subsurface optical structure having multiple substructures 310. In some embodiments, the one or more processors may be configured to generate, based on the first phase-wrapped wavefront, energy output parameters for forming a first optical structure using an energy source. In some embodiments, the first optical structure may be configured to refract light directed at the retina of the patient so as to improve vision. In some embodiments, the optical structure may be a subsurface optical structure. For example, referencing the cross-section illustrated in FIG. 3, the optical structure may be a subsurface optical structure having multiple substructures 310 that may be concentric. An example schematic of a top view of such a configuration is illustrate in FIG. 2B, with concentric substructures 14. These concentric substructures may be Fresnel rings that result in an ophthalmic lens that may be a Fresnel lens. The subsurface optical structures may be achieved by focusing laser pulses appropriately to depths within the ophthalmic lens to cause changes in refractive property to sub-volumes in the interior of the ophthalmic lens.

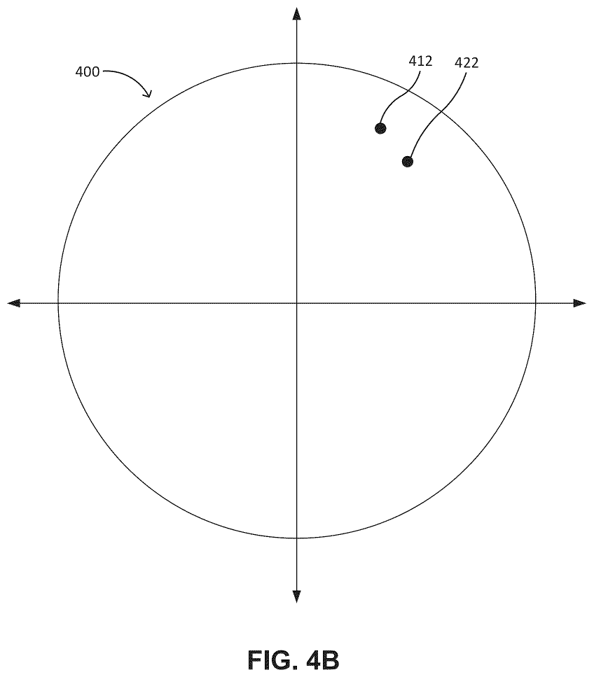

FIGS. 4A-4B illustrate example conceptualizations of an ophthalmic lens 400 that may be defined by a plurality of focal positions within the ophthalmic lens 400. In some embodiments, an ophthalmic lens may be divided up into a plurality of pixels, each pixel corresponding to a focal position. Such a pixel may be a sub-region or a sub-volume of an ophthalmic lens. FIG. 4A shows the ophthalmic lens 400 divided up into a plurality of pixels (e.g., the pixels 410 and 420) in a grid fashion. Although FIG. 4A illustrates uniform pixels that are square shaped, this disclosure contemplates that pixels may be of any suitable shape (e.g., hexagonal, pentagonal, circular, spiral) and that they may not be uniform (e.g., they may of different shapes and sizes). A pixel area may correspond to the resolution of an energy delivery system (e.g., a laser system) configured to form an optical structure corresponding to a phase-wrapped wavefront. That is, a pixel area may correspond to a minimum area of a subregion of the ophthalmic lens at which the energy delivery system may focus an energy beam (e.g., a femtosecond laser that emits pulsed laser beams, a continuous wave laser) to change a refractive index of the sub-volume associated with the sub-region. FIG. 4B illustrates another conceptualization of an ophthalmic lens, where the ophthalmic lens is not divided up into discrete pixels. Instead, the ophthalmic lens is mapped out using a coordinate system (e.g., a two-dimensional x-y coordinate system, a three-dimensional x-y-z coordinate system, or a polar coordinate system (radius and angle)). For example, the points 412 and 422 may each have a respective coordinate in the coordinate system. Although FIGS. 4A-4B are in two dimensions, it should be appreciated that ophthalmic lenses are three-dimensional, and focal positions may be defined in three dimensions.

In some embodiments, in order to create suitable subsurface structures, each focal position may need to have an energy beam directed at it at a predetermined power level (e.g., in Watts) for a predetermined period of time (e.g., a few nanoseconds to microseconds). For example, referencing FIG. 4A, a first energy beam may be delivered (e.g., in femtosecond pulses) to the pixel 410 at a first power level for a first period of time, and a second energy beam may be delivered (e.g., in femtosecond pulses) to the pixel 420 at a second power level for a second period of time. Similarly, referencing FIG. 4B, a first energy beam may be delivered (e.g., in femtosecond pulses) to the point 410 at a first power level for a first period of time, and a second energy beam may be delivered (e.g., in femtosecond pulses) to the point 420 at a second power level for a second period of time. Although FIGS. 4A-4B are two-dimensional, it is to be appreciated that the ophthalmic lenses are three-dimensional, and as such, the pixels or points may be defined in three dimensions (e.g., by three-dimensional coordinate system). For example, referencing FIG. 4B, the point 412 may be defined by an x-y-z coordinate (e.g., with the z-coordinate specifying a depth at which energy is to be delivered in forming an optical structure).

As can be appreciated by the discussion above, forming optical structures and an ophthalmic lens requires coordinating both power and position of a laser beam. Forming optical structures requires high precision and resolution, such that a large number of focal positions (e.g., 10 million, 50 million) need to be targeted by an energy beam. Each of these focal positions on the ophthalmic lens will have associated a unique power level and a position value (e.g., a coordinate). A system that coordinates power and position of the laser beam must be able to adjust power levels and position the laser beam accurately across the large number of focal positions so as to create an effective ophthalmic lens. Furthermore, such a system must be able to do so rapidly to achieve sufficient throughput (e.g., because of the large number of focal positions required). This is especially the case when the ophthalmic lens is the human cornea of a patient, in which case the surface of the eye of the patient may need to be flattened or fixed to a degree during the treatment process. As such, it may be uncomfortable and/or unsafe to prolong the process for much longer than, for example, two minutes. In this example, performing a treatment that may involve 50 million focal positions in two minutes requires very rapid, precise coordination.

Disclosed herein are methods for coordinating a power and a position of a laser beam for forming subsurface optical structures in an ophthalmic lens. As described above, the subsurface optical structures may be volumes within the ophthalmic lens having adjusted refractive indexes such that they refract/diffract light in a desired manner (e.g., so as to correct or improve vision in a patient). In some embodiments, such a method may include loading an ordered list of power values on a memory associated with a power-control computing device, wherein the power values correspond to desired laser power levels for the laser beam.

In some embodiments, the method may include receiving one or more treatment planning inputs, which may be inputs supplied by one or more of a physician, a manufacturer, etc. The treatment planning inputs may include any suitable information or parameters for creating a plan configured to form subsurface structures in an ophthalmic lens as desired, such as material specifications of the ophthalmic lens, desired optical changes (e.g., based on a prescription), pattern requirements, and system calibration information. For example, in the case of an ophthalmic lens that is a contact lens, the material specifications may include information about the material properties of the contact lens. As another example, in the case of an ophthalmic lens that is a human cornea, the material specifications may include information about the properties of the human cornea. As another example, the system calibration information may include information about the power of the laser beam or the actuators associated with of the galvos and stages (elements that will be described in further detail below).

In some embodiments, a treatment planning system may receive the treatment planning inputs and output a scanning control program. The scanning control program may include instructions for positioning a laser beam along different focal positions on an ophthalmic lens to achieve a desired pattern to achieve a desired treatment as determined based on the treatment planning inputs. In some embodiments, the treatment planning system may first output a pattern generation program that generates a treatment pattern for the ophthalmic lens, and the scanning control program may be generated based on this pattern generation program.

In some embodiments, the treatment planning system may also output a list of power data values (e.g., an ordered list of power data values that is ordered so as to map onto focal positions on the ophthalmic lens that would be expected at given times based on the scanning control program). The power data values may be based on the treatment planning inputs, a treatment pattern may be generated. In some embodiments, the treatment planning system may be a stand-alone system with dedicated software. In other embodiments, the treatment planning system may be a software module within the overarching coordination software further described herein.

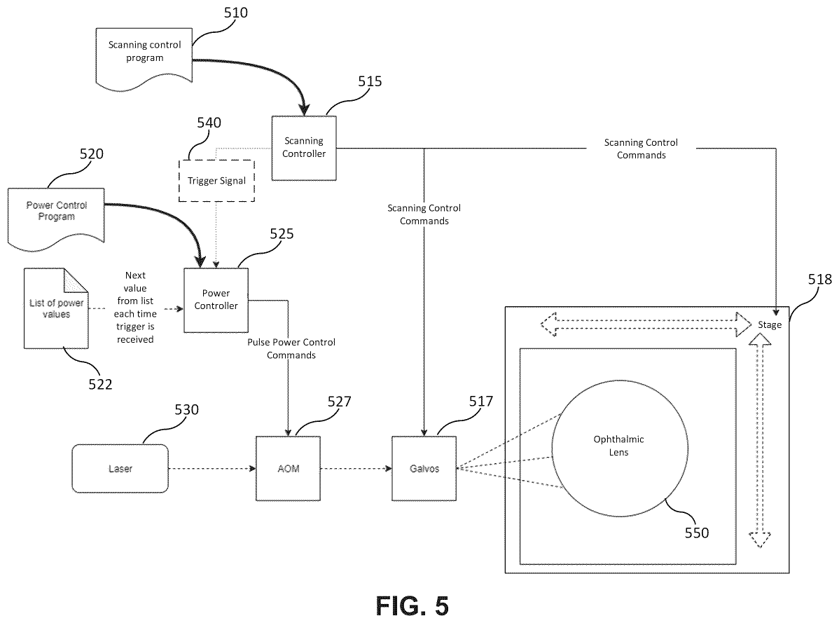

FIG. 5 illustrates an example schematic of a system that coordinates the power and position of a laser beam. In some embodiments, the method may include loading a scanning control program on a scanning-control computing device. In some embodiments, loading a scanning control program may include first loading a treatment pattern program, which the scanning-control computing device may use to generate the scanning control program. In other embodiments, the scanning control program may be loaded directly onto the scanning-control computing device. In some embodiments, the scanning-control computing device may be a programmable scanning controller that may be capable of controlling the position of a laser beam on an ophthalmic lens that is the subject of treatment. The scanning control program may include instructions for generating scanning control commands to position the laser beam, and the scanning-control computing device may execute these instructions to position the laser beam. For example, the scanning-control computing device may be capable of controlling a stage on which the ophthalmic lens rests (or on which a laser source rests) so as to translate the laser beam from a first position to a second position on the ophthalmic lens (e.g., from a first focal position to a second focal position). Additionally or alternatively, the scanning-control computing device may be capable of controlling galvos for adjusting a direction of the laser beam that is directed at the ophthalmic lens. Referencing the example illustrated in FIG. 5, the scanning control program 510 may be loaded onto the scanning controller 515, which may issue scanning control commands based on the scanning control program 510 to the galvos 517 and/or the stage 518 so as to position the laser beam. Although the disclosure focuses on lasers and laser sources, the disclosure contemplates the use of any suitable energy beam from any suitable energy source. In some embodiments, the scanning control program may also include instructions corresponding to speeds associated with positioning the laser beam. For example, the scanning control program may include instructions for a speed at which galvos adjust the direction of the laser beam, and/or a speed at which the stage is moved to translate the laser beam. In some embodiments, the scanning control program may include instructions corresponding to periods of time during which the laser beam may be made to rest at a particular position.

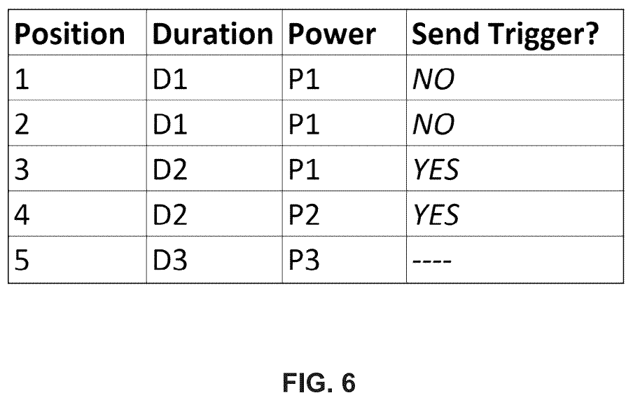

FIG. 6 illustrates a table representing a subset of a treatment plan for forming an optical structural on an ophthalmic lens. In some embodiments, the method may include causing the laser beam to be directed at a first power level toward a first focal position on the ophthalmic lens. For example, referencing FIG. 6, a laser beam may be caused to be directed at a first focal position (e.g., focal position 1) at a first power level (e.g., P1). The power level may be characterized, for example, in Watts, or by any other suitable intensity measure. The first power level may correspond to a first power value on the ordered list of power values. As an example, the ordered list of power values may include power values P1, P2, P3, . . . , PN. In some embodiments, the power of the laser beam directed at the ophthalmic lens may be controlled by a power-control computing device, which in some embodiments may be a separate device from the scanning-control computing device. For example, referencing, FIG. 5, the power of the laser beam directed at the ophthalmic lens may be controlled by the power controller 525 (e.g., a programmable I/O card). Separating the scanning controller 515 from the power controller 525 may be advantageous in that it provides dedicated devices for separately and simultaneously performing the processing tasks necessary for controlling these two aspects (power and position of the laser beam). Separating the scanning-control computing device from the power-control computing device may be advantageous in that it provides dedicated devices for separately and simultaneously performing the processing tasks necessary for controlling these two aspects (power and position of the laser beam). Such a configuration may significantly reduce the overall processing time, thereby allowing for higher throughput. In some embodiments, the power controller 525 may receive a power value (e.g., referencing FIG. 6, corresponding to the power level P1) from the list of power values 522. The power controller 525 may then issue power control commands that are configured to adjust the power of the laser beam directed at the ophthalmic lens to a desired power level (e.g., P1). In some embodiments, as illustrated in FIG. 5, the power of the laser beam may be controlled by the power controller 525 using an acousto-optic modulator (AOM) 527. The AOM 527 may include a piezoelectric transducer that vibrates a material (e.g., glass, quartz) through which an input laser beam from the laser 530 is made to travel. The power level of the laser beam pulse output from the AOM 527 can be controlled by controlling the vibration amplitude. This is known as the acousto-optic effect, which is a well-known phenomenon to one of skill in the art. The vibration may be varied between any suitable range so as to vary the power level of the laser beam between any suitable range. The AOM may be used to adjust the power level of the laser beam pulses very precisely at small increments in microsecond time frames with the switching performed by the AOM on the order of nanoseconds. In some embodiments, the AOM 527 may be able to reduce the power level to zero such that a laser beam is not made incident on the ophthalmic lens 550 for a period of time. Alternatively or additionally, a mechanical means (e.g., a physical shutter disposed somewhere between the laser 530 and the ophthalmic lens 550) may be used to ensure that a laser beam is not made incident on the ophthalmic lens 550 for a period of time. Although the disclosure focuses on using AOMs, the disclosure contemplates the use of any suitable device or means for modulating laser beams (or other suitable energies).

In some embodiments, the method may include sending (e.g., by the scanning-control computing device) a first scanning control command to move the laser beam from the first focal position to a second focal position. For example, referencing FIG. 5, the first scanning control command may be a command to the galvos 517, to the stage 518, or to both the galvos 517 and the stage 518. Galvos, short for mirror galvanometers, may be used to change an angle of an incident beam and thereby change its direction and point of incidence on the ophthalmic lens 550. The galvos may make use of actuators that swivel or rotate mirrors and may make use of additional optical elements in concert with the galvos so as to steer an incident beam in a desired direction. The use of galvos to direct beams is well known. As mentioned above, the galvos 517 may be moved to change the direction of the laser beam as needed. In some embodiments, the stage 518 may be a structure on which the ophthalmic lens 550 is disposed, and the stage 518 may be movable (e.g., using one or more actuators) in two or three dimensions. For example, referencing FIG. 5, the stage 518 may be movable in two dimensions as indicated by the arrows (along the x-y plane) so as to move the ophthalmic lens 550 that is disposed on the stage 518. The stage 518 may also be movable in three dimensions (along the z-axis) so as to change the depth at which a laser beam is incident on the ophthalmic lens 550. In other embodiments, the stage may be a structure on which the laser rests. This may be the case, for example, where the ophthalmic lens itself remains stationary. For example, when the ophthalmic lens is a cornea of a patient, the ophthalmic lens may remain stationary while the stage, which may be disposed above the eye of the patient, may be moved (e.g., in three dimensions). As such, in this example, the patient does not need to be moved during a procedure on the patient's cornea. In some embodiments, the ophthalmic lens may be on a first stage and the laser may be on a second stage, such that both the ophthalmic lens and the laser may be movable by sending commands to actuators corresponding to their respective stages.

In some embodiments, the method may include sending a first trigger signal to the power-control computing device. The first trigger signal may be an instruction configured to cause the power-control computing device to fetch a second power value. In some embodiments, the trigger signal may be sent by the scanning-control computing device to the power-control computing device. For example, referencing FIG. 5, the trigger signal 540 may be sent by the scanning controller 515 to the power controller 525. In response, the power controller 525 may fetch, from the list of power values 522, a second power value. For instance, referencing FIG. 6, a trigger signal may be sent after a laser beam has been directed at focal position 3 at a power level of P1 for a duration of D2. In response, a new power value P2 may be fetched from the list of power values 522, such that when the laser beam is directed at focal position 4, the power level is set to P2 (as noted in the table illustrated in FIG. 6). In some embodiments, the list of power values 522 may be stored on a memory device that is communicatively coupled with the power controller 525. In some embodiments, the trigger signal may only be sent when a different power level is needed (e.g., as may be determined based on the scanning control program). For example, the scanning controller 515 may only send a trigger signal when it determines that the scanning control program 510 that is loaded on the scanning controller 515 requires a different power level. In these embodiments, the second power value that is fetched (and the corresponding second power level) is different from the first power value (and the corresponding first power level). In other embodiments, the trigger signal may be sent whenever the laser beam moves to a new focal position, or alternatively, the signal may be sent periodically (e.g., at regular time intervals).

In some embodiments, the method may include causing (e.g., by the power-control computing device) the laser beam to be directed at the second focal position at a second power level corresponding to the second power value. For example, referencing FIG. 5, the power controller 525 may send a laser power command to the AOM 527 instructing the AOM 527 to modulate an input laser beam received from the laser 530 in such a manner so as to make the output beam to have a second power level correspond to the second power value.

Varying the power level of the laser beam as it is made incident on a particular focal position varies the amount of refractive change at the particular focal position. In this way, subsurface structures with desired refractive/diffractive properties may be created in ophthalmic lens by moving the laser beam across the ophthalmic lens and varying power accordingly. In some embodiments, the amount of time a laser beam is made incident on a particular focal position can be varied so as to allow for further control. That is, increasing this duration for a particular focal position can cause a greater refractive change. In some embodiments, a desired duration may be achieved by allowing the laser beam to remain stationary at a particular focal position for a specified duration. In other embodiments, a desired duration may be achieved by varying the speed at which the laser beam moves from a first focal position to a second focal position. For example, reducing the speed at which the laser beam is moved from the first focal position to the second focal position increases the duration (e.g., at the first focal position and also at points between the first focal position and the second focal position). Similarly, increasing the speed at which the laser beam is moved from the first focal position to the second focal position reduces the duration.

The example in FIG. 6 (with reference to the elements of FIG. 5) is illustrative in tying all these concepts together. A treatment may start at focal position 1, where a laser beam is directed at a power level of P1 for a duration of D1. Next, one or more scanning control commands may be sent by the scanning controller 515 to the galvos 517 and/or the stage 518 so as to move the laser beam to focal position 2, where the laser beam is directed at the same power level of P1 for a duration of D1. Next, one or more scanning control commands may be sent by the scanning controller 515 so as to move the laser beam to focal position 3, where the beam is directed at the same power level of P1 for a duration of D2. At this point, the scanning controller 515 may determine that a trigger signal 540 needs to be sent because the next focal position (focal position 4) requires a different power level. As such, the scanning controller 515 may send such a trigger signal 540 to the power controller 525, which may fetch a power value from the list of power values 522 (e.g., the power value corresponding to P2, which may be next in sequence from the power value corresponding to P1 on the list of power values 522). The power controller 525 may then send a power control command to the AOM 527 so as to adjust the power level of the laser beam to the power level P2. The scanning controller 515 may also send scanning control commands configured to move the galvos 517 and/or the stage 518 so as to direct the laser beam at focal position 4 for a duration of D2. Another trigger signal 540 may be sent so as to fetch a new power value that corresponds to the power level P3, and the laser beam may be directed at focal position 5 for a duration of D3. This process may continue until all focal positions on the ophthalmic lens are treated (e.g., 2-10 million focal positions). Although this discussion of FIG. 6 suggests achieving desired durations by allowing the laser beam to remain stationary for a desired period, the disclosure contemplates that the desired durations may be achieved by varying the speed at which the laser beam moves (as described previously).

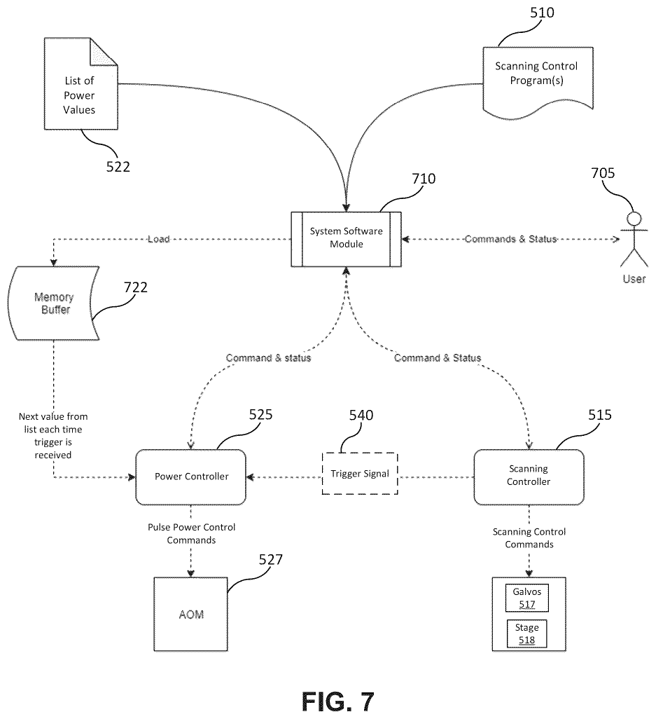

FIG. 7 illustrates an example schematic of the system shown in FIG. 5, but from a different viewpoint so as to depict how a central system software module 710 coordinates the power and position of a laser beam in the manner described above. As illustrated, a scanning control program 510 and a list of power values 522 may be loaded onto a computing device, and may be accessed by a system software module 710 being executed on the computing device. In some embodiments, the computing device may receive commands from the user 705 as user inputs for the system software module 710. In some embodiments, the system software module 710 may also output information such as status information to the user 705. For example, the system software module 710 may output information about progress for completing a substructure in an ophthalmic lens (e.g., showing a percentage of completion).

In some embodiments, the system software module 710 may load one or more scanning control programs onto the scanning controller 515, which sends scanning control commands to actuate one or more galvos 517 and/or one or more stages 518. In some embodiments, the system software module 710 may load one or more power control programs onto the power controller 525 (e.g., a programmable I/O card), which sends laser power commands to the AOM 525 so as to modulate laser power). Such power control programs may include instructions for generating power control commands for modulating the power of a laser beam (e.g., instructions to the AOM 525 to effect such modulation) to a desired power level. In some embodiments, the system software module 710 may send commands directly to the power controller 525 and/or the scanning controller 515.

In some embodiments, the system software module 710 may load onto a memory buffer 722 the list of power values 522. As discussed previously, the scanning controller 515 may, based on the scanning control program 510, send trigger signals 540 whenever a new power value is needed. When the trigger signal is received, the power controller 525 may access the memory buffer 722 to retrieve a next power value from the list of power values 522 (or alternatively, the next power value be pushed to the power controller 525). In some embodiments, the power controller 525 may send power control commands to the AOM 527 to modulate the laser beam according to a current power value (e.g., the power value that was most recently fetched from the memory buffer 722).

In some embodiments, the system software module 710 may receive feedback information from the power controller 525 and/or the scanning controller 515. This feedback information may include status information. In some embodiments, the status information may be used to determine errors or fault conditions at the level of the power controller 525 or the scanning controller 515. For example, status information from the scanning controller 515 may be used to determine if there are mechanical issues with the actuators of the galvos 517 and/or the stage 518. As another example, status information from the scanning controller 515 may send back in error if the system software module 715 issues a command that attempts to make an actuator (e.g. of the stage 518 and/or the galvos 517) move too quickly. As another example, status information from the power controller 525 or the scanning controller 515 may be used to determine if there is a corruption in any of their respective programs. As another example, status information from the power controller 525 or the scanning controller 515 may send back information that may be used to determine if there is an electrical short, if a cable is loose, or any other such electrical issues. In some embodiments, there may be a submodule within the system software module 710 that may be capable of receiving these statuses, determining an error or fault condition, and either resolving the error or fault condition or sending a notification to the user 705 via a user interface. In some embodiments, this submodule may continuously (e.g., periodically) monitor the system for errors.

In some embodiments, the system software module 710 may be able to coordinate the power levels and positions of multiple laser beams on multiple ophthalmic lenses. For example, the system software module 710 may be able to simultaneously or near-simultaneously coordinate the power levels and positions of five different lasers to form subsurface structures in five different ophthalmic lenses (e.g., five contact lenses). This can significantly improve throughput. Building on the previous example, if the five ophthalmic lenses are all to have the same subsurface structures, the same set of commands could be sent to five different sets of AOMs and actuators (e.g., actuators for galvos and/or stages). This would significantly reduce the need for processing resources in executing the processes required to coordinate power and position of the laser beams, because many of the processing tasks (e.g., the execution of the scanning control program, the sending of trigger signals, the accessing of power values from a memory buffer to fetch in next power value, etc.) only need to be performed once for each corresponding focal position of the five different ophthalmic lenses.

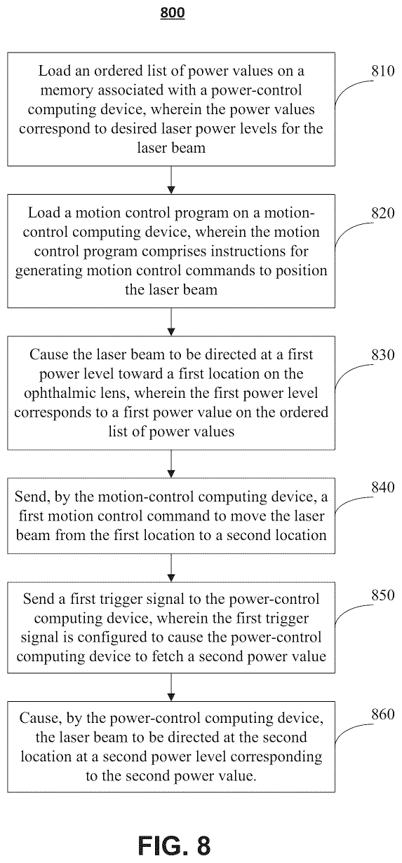

FIG. 8 illustrates an example method 800 for coordinating a power and a position of a laser beam for forming a subsurface optical structure in an ophthalmic lens (e.g., for improving vision in a patient). The method may include, at step 810, loading an ordered list of power values on a memory associated with a power-control computing device, wherein the power values correspond to desired laser power levels for the laser beam. At step 820, the method may include loading a scanning control program on a scanning-control computing device, wherein the scanning control program includes instructions for generating scanning control commands to position the laser beam. At step 830, the method may include causing the laser beam to be directed at a first power level toward a first focal position on the ophthalmic lens, wherein the first power level corresponds to a first power value on the ordered list of power values. At step 840, the method may include sending, by the scanning-control computing device, a first scanning control command to move the laser beam from the first focal position to a second focal position. At step 850, the method may include sending a first trigger signal to the power-control computing device, wherein the first trigger signal is configured to cause the power-control computing device to fetch a second power value. At step 860, the method may include causing, by the power-control computing device, the laser beam to be directed at the second focal position at a second power level corresponding to the second power value.

Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for coordinating a power and a position of a laser beam for forming a subsurface optical structure in an ophthalmic lens, including the particular steps of the method of FIG. 8, this disclosure contemplates any suitable method for coordinating a power and a position of a laser beam for forming a subsurface optical structure in an ophthalmic lens, including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8. Finally, although the steps of the method of FIG. 8 are listed as distinct steps, the disclosure contemplates that any of the steps may be performed in combination (e.g., simultaneously and concurrently).

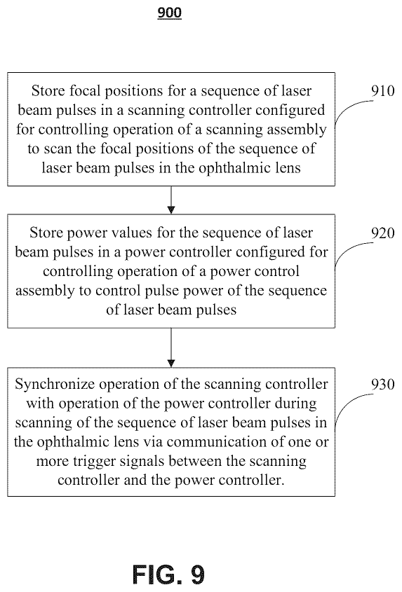

FIG. 9 illustrates an example method 900 for controlling a laser beam pulse scanning device and a laser beam pulse power-control device to form a subsurface optical structure in an ophthalmic lens. The method may include, at step 910, storing focal positions for a sequence of laser beam pulses in a scanning controller configured for controlling operation of a scanning assembly to scan the focal positions of the sequence of laser beam pulses in the ophthalmic lens. At step 920, the method may include storing power values for the sequence of laser beam pulses in a power controller configured for controlling operation of a power control assembly to control pulse power of the sequence of laser beam pulses. At step 930, the method may include synchronizing operation of the scanning controller with operation of the power controller during scanning of the sequence of laser beam pulses in the ophthalmic lens via communication of one or more trigger signals between the scanning controller and the power controller.

Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for controlling a laser beam pulse scanning device and a laser beam pulse power-control device to form a subsurface optical structure in an ophthalmic lens, including the particular steps of the method of FIG. 9, this disclosure contemplates any suitable method for controlling a laser beam pulse scanning device and a laser beam pulse power-control device to form a subsurface optical structure in an ophthalmic lens, including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9. Finally, although the steps of the method of FIG. 9 are listed as distinct steps, the disclosure contemplates that any of the steps may be performed in combination (e.g., simultaneously and concurrently).

Example 1 is a method of controlling a laser beam pulse scanning device and a laser beam pulse power-control device to form a subsurface optical structure in an ophthalmic lens. The example 1 method includes: storing focal positions for a sequence of laser beam pulses in a scanning controller configured for controlling operation of a scanning assembly to scan the sequence of laser beam pulses to the focal positions in the ophthalmic lens; storing pulse power data values corresponding to pulse powers for the sequence of laser beam pulses in a memory accessible by a pulse power controller configured for controlling operation of a power control assembly to control pulse powers of the sequence of laser beam pulses; and synchronizing operation of the scanning controller with operation of the pulse power controller during scanning of the sequence of laser beam pulses to the focal positions in the ophthalmic lens via communication of one or more trigger signals between the scanning controller and the pulse power controller.

Example 2 is the method of example 1, further comprising: loading a power control program into the pulse power controller, wherein the power control program comprises instructions for generating power control commands for controlling the power control assembly to control pulse powers of the sequence of laser beam pulses; and loading a scanning control program into the scanning controller, wherein the scanning control program comprises instructions for controlling operation of the scanning assembly to control scanning of the sequence of laser beam pulses to the focal positions in the ophthalmic lens.

Example 3 is the method of example 1, wherein the pulse power controller comprises a digital input/output (I/O) card.

Example 4 is the method of example 1, wherein: each of the one or more trigger signals comprises an instruction to retrieve a new pulse power data value from the memory; and the new pulse power data value corresponds to a pulse power for a laser beam pulse that is next in the sequence of laser beam pulses.

Example 5 is the method of example 1, further comprising loading a scanning control program into the scanning controller, wherein scanning control program controls transmission of the one or more trigger signals.

Example 6 is the method of example 1, further comprising controlling an acousto-optic modulator disposed in between a laser pulse source and the ophthalmic lens to control pulse powers of the sequence of laser beam pulses scanned to the focal positions in the ophthalmic lens.

Example 7 is the method of example 1, further comprising controlling an electro-optic modulator disposed in between a laser pulse source and the ophthalmic lens to control pulse powers of the sequence of laser beam pulses scanned to the focal positions in the ophthalmic lens.

Example 8 is the method of example 1, further comprising: receiving a definition of the subsurface optical structure; and generating the focal positions and pulse powers of the sequence of laser beam pulses based on the definition of the subsurface optical structure.

Example 9 is the method of example 1, further comprising determining one or more scanning speeds for scanning the sequence of laser beam pulses to the focal positions in the ophthalmic lens.

Example 10 is the method of any one of examples 1 through 9, wherein: the scanning assembly comprises one or more laser galvos and a depth of focus mechanism; the one or more laser galvos are operable to control scanning of the sequence of laser beam pulses to the focal positions in the ophthalmic lens in two directions transverse to a direction of propagation of the sequence of laser beam pulses; and the depth of focus mechanism is operable to control scanning of the sequence of laser beam pulses to the focal positions in the ophthalmic lens in the direction of propagation of the sequence of laser beam pulses.

Example 11 is the method of any one of examples 1 through 9, wherein the ophthalmic lens is disposed on a movable stage, the method further comprising controlling positioning of the movable stage during scanning of the sequence of laser beam pulses to the focal positions in the ophthalmic lens.

Example 12 is the method of any one of examples 1 through 9, further comprising: causing a laser pulse source to emit the sequence of laser beam pulses, wherein the laser pulse source is mounted to a movable stage; and controlling positioning of the movable stage during scanning of the sequence of laser beam pulses to the focal positions in the ophthalmic lens.

Example 13 is a method of coordinating control power and scanning of a sequence of laser beam pulses to focal positions in an ophthalmic lens to form a subsurface optical structure in the ophthalmic lens. The example 13 method includes: loading an ordered list of pulse power data values for the sequence of laser beam pulses on a memory accessible by a power-control computing device, wherein the ordered list of pulse power data values is indicative of pulse powers for the sequence of laser beam pulses; loading a scanning control program into a scanning-control computing device, wherein the scanning control program comprises instructions for generating scanning control commands to control a scanning assembly to direct the sequence of laser beam pulses to the focal positions in the ophthalmic lens; controlling a power control assembly by the power-control computing device to cause a first laser beam pulse of the sequence of laser beam pulses to have a first pulse power corresponding to a first pulse power data value of the ordered list of pulse power data values; controlling a scanning assembly by the scanning-control computing device to direct the first laser beam pulse to a first focal position of the focal positions in the ophthalmic lens; sending a first trigger signal to the power-control computing device, wherein receipt of the first trigger signal by the power-control computing device causes the power-control computing device to control the power control assembly to cause a second laser beam pulse of the sequence of laser beam pulses to have a second pulse power corresponding to a second pulse power data value of the ordered list of pulse power data values for the sequence of laser beam pulses; and controlling the scanning assembly by the scanning-control computing device to direct the second laser beam pulse to a second focal position of the focal positions in the ophthalmic lens.

Example 14 is the method of example 13, wherein the power-control computing device comprises a digital input/output (I/O) card.

Example 15 is the method of example 13, wherein the scanning-control computing device comprises a programmable scanning controller.

Example 16 is the method of example 13, wherein the first trigger signal is generated by the scanning-control computing device, and wherein the scanning control program controls transmission of the first trigger signal by the scanning-control computing device.

Example 17 is the method of example 16, wherein the scanning control program specifies when a new pulse power data value of the ordered list of pulse power data values is needed, and wherein the second pulse power data value is next in sequence to the first pulse power data value on the ordered list of pulse power data values.

Example 18 is the method of example 13, wherein the power control assembly comprises an acousto-optic modulator.

Example 19 is the method of example 13, wherein the power control assembly comprises an electro-optic modulator.

Example 20 is the method of example 13, further comprising: receiving data defining the subsurface optical structure; and generating the scanning control program based on the data defining the subsurface optical structure.

Example 21 is the method of example 13, further comprising: sending a second trigger signal to cause the power-control computing device to fetch a third pulse power data value; and controlling, by the power-control computing device, the power control assembly to cause a laser beam pulse of the sequence of laser beam pulses to have a third pulse power level.

Example 22 is the method of any one of examples 13 through 21, wherein: the scanning assembly comprises one or more laser galvos and a depth of focus mechanism; the one or more laser galvos are operable to control direction for each of the sequence of laser beam pulses in two directions transverse to a direction of propagation of the sequence of laser beam pulses; and the depth of focus mechanism is operable to control depth of focus for each of the sequence of laser beam pulses in the direction of propagation of the sequence of laser beam pulses.

Example 23 is the method of any one of examples 13 through 21, wherein the ophthalmic lens is disposed on a movable stage, and further comprises controlling, by the scanning-control computing device, positioning of the movable stage during the scanning of the sequence of laser beam pulses to the focal positions in the ophthalmic lens.

Example 24 is the method of any one of examples 13 through 21, wherein a laser pulse source from which the sequence of laser beam pulses is emitted is disposed on a movable stage, and further comprises controlling, by the scanning-control computing device, positioning of the movable stage during the scanning of the sequence of laser beam pulses to the focal positions in the ophthalmic lens.

Example 25 is a system for forming a subsurface optical structure in an ophthalmic lens. The example 25 system includes: a laser beam pulse source operable to emit a sequence of laser beam pulses; a power control assembly operable to control a pulse power of each of the sequence of laser beam pulses; a scanning assembly operable to scan the sequence of laser beam pulses to designated focal positions within the ophthalmic lens; a power controller configured to control operation of the power control assembly, wherein the power controller stores pulse power data values corresponding to pulse power values for the sequence of laser beam pulses and controls operation of the power control assembly based on the pulse power data values; and a scanning controller configured to control operation of the scanning assembly, wherein the scanning controller stores focal position data defining the designated focal positions for the sequence of laser beam pulses and controls operation of the scanning assembly based on the focal position data, wherein operation of the scanning assembly and operation of the power control assembly is coordinated via communication of one or more trigger signals between the scanning controller and the power controller.

Example 26 is the system of example 25, wherein the power controller comprises a digital input/output (I/O) card.

Example 27 is the system of example 25, wherein the one or more trigger signals are generated by the scanning controller, and wherein the scanning controller transmits the one or more trigger signals as directed by a scanning control program loaded on the scanning controller.

Example 28 is the system of example 25, wherein the power control assembly comprises an acousto-optic modulator.

Example 29 is the system of example 25, wherein the power control assembly comprises an electro-optic modulator.

Example 30 is the system of any one of examples 25 through 29, wherein: the scanning assembly comprises a movable stage and a depth of focus mechanism; the movable stage is configured for mounting of the ophthalmic lens to the movable stage; and the scanning controller controls positioning of the movable stage to control position of the ophthalmic lens relative to the depth of focus mechanism during scanning of the sequence of laser beam pulses to the designated focal positions in the ophthalmic lens.

Example 31 is the system of any one of examples 25 through 29, further comprising a movable stage, wherein the laser beam pulse source is disposed on the movable stage, and wherein the scanning controller controls positioning of the laser beam pulse source relative to the ophthalmic lens during scanning of the sequence of laser beam pulses to the designated focal positions in the ophthalmic lens.

Example 32 is a system for coordinating pulse power and focal positions for a sequence of laser beam pulses for forming a subsurface optical structure in an ophthalmic lens. The example 32 system includes: a laser beam pulse source operable to emit the sequence of laser beam pulses; a scanning assembly operable to scan the sequence of laser beam pulses to focal positions within the ophthalmic lens; a movable stage; a power-control computing device comprising a power-control memory, wherein the power-control memory is configured to store an ordered list of pulse power data values corresponding to pulse power values for the sequence of laser beam pulses; a power control assembly operable to control pulse power of each of the sequence of laser beam pulses; and a scanning-control computing device comprising a scanning-control memory, wherein the scanning-control memory stores a scanning control program comprising instructions for controlling a scanning assembly to direct the sequence of laser beam pulses to the focal positions in the ophthalmic lens; wherein: the scanning-control computing device is configured to send a trigger signal to the power-control computing device to cause the power-control computing device to sequentially fetch a pulse power data value from the ordered list of pulse power data values; and the power-control computing device is configured to control the power control assembly based on the pulse power data value to control pulse power of a laser beam pulse of the sequence of laser beam pulses.

Example 33 is the system of example 32, wherein the power-control computing device comprises a digital input/output (I/O) card.

Example 34 is the system of example 32, wherein the scanning-control computing device comprises a programmable scanning controller.

Example 35 is the system of example 32, wherein the trigger signal is generated by the scanning-control computing device, and wherein the scanning control program controls transmission of the trigger signal by the scanning-control computing device.

Example 36 is the system of example 35, wherein the scanning control program specifies when a new pulse power data value is needed, and wherein the new pulse power data value is next in sequence to a current pulse power data value on the ordered list of pulse power data values.

Example 37 is the system of any one of examples 32 through 36, wherein: the scanning assembly comprises one or more laser galvos and a depth of focus mechanism; the one or more laser galvos are operable to control direction of each of the sequence of laser beam pulses in two directions transverse to a direction of propagation of the laser beam pulse; and the depth of focus mechanism is operable to control depth of focus for each of the sequence of laser beam pulses in the direction of propagation of the laser beam pulse.

Example 38 is the system of any one of examples 32 through 36, wherein: the ophthalmic lens is disposed on the movable stage; and the scanning-control computing device controls positioning of the movable stage relative to the laser beam pulse source.

Example 39 is the system of any one of examples 32 through 36, wherein: the laser beam pulse source is disposed on the movable stage; and the scanning-control computing device controls positioning of the movable stage relative to the ophthalmic lens.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A method of controlling a laser beam pulse scanning device and a laser beam pulse power-control device to form a subsurface optical structure in an ophthalmic lens, the method comprising:
storing focal positions for a sequence of laser beam pulses in a scanning controller configured for controlling operation of a scanning assembly to scan the sequence of laser beam pulses to the focal positions in the ophthalmic lens;
storing pulse power data values corresponding to pulse powers for the sequence of laser beam pulses in a memory accessible by a pulse power controller configured for controlling operation of a power control assembly to control pulse powers of the sequence of laser beam pulses; and
synchronizing operation of the scanning controller with operation of the pulse power controller during scanning of the sequence of laser beam pulses to the focal positions in the ophthalmic lens via communication of one or more trigger signals between the scanning controller and the pulse power controller.

2. The method of claim 1, further comprising:
loading a power control program into the pulse power controller, wherein the power control program comprises instructions for generating power control commands for controlling the power control assembly to control pulse powers of the sequence of laser beam pulses; and
loading a scanning control program into the scanning controller, wherein the scanning control program comprises instructions for controlling operation of the scanning assembly to control scanning of the sequence of laser beam pulses to the focal positions in the ophthalmic lens.

3. (canceled)

4. The method of claim 1, wherein:
each of the one or more trigger signals comprises an instruction to retrieve a new pulse power data value from the memory; and
the new pulse power data value corresponds to a pulse power for a laser beam pulse that is next in the sequence of laser beam pulses.

5. The method of claim 1, further comprising loading a scanning control program into the scanning controller, wherein scanning control program controls transmission of the one or more trigger signals.

6. The method of claim 1, further comprising controlling an acousto-optic modulator disposed in between a laser pulse source and the ophthalmic lens to control pulse powers of the sequence of laser beam pulses scanned to the focal positions in the ophthalmic lens.

7. The method of claim 1, further comprising controlling an electro-optic modulator disposed in between a laser pulse source and the ophthalmic lens to control pulse powers of the sequence of laser beam pulses scanned to the focal positions in the ophthalmic lens.

8. The method of claim 1, further comprising:
receiving a definition of the subsurface optical structure; and
generating the focal positions and pulse powers of the sequence of laser beam pulses based on the definition of the subsurface optical structure.

9. The method of claim 1, further comprising determining one or more scanning speeds for scanning the sequence of laser beam pulses to the focal positions in the ophthalmic lens.

10. The method of claim 1, wherein:
the scanning assembly comprises one or more laser galvos and a depth of focus mechanism;
the one or more laser galvos are operable to control scanning of the sequence of laser beam pulses to the focal positions in the ophthalmic lens in two directions transverse to a direction of propagation of the sequence of laser beam pulses; and
the depth of focus mechanism is operable to control scanning of the sequence of laser beam pulses to the focal positions in the ophthalmic lens in the direction of propagation of the sequence of laser beam pulses.

11. The method of claim 1, wherein the ophthalmic lens is disposed on a movable stage, the method further comprising controlling positioning of the movable stage during scanning of the sequence of laser beam pulses to the focal positions in the ophthalmic lens.

12. The method of claim 1, further comprising:
causing a laser pulse source to emit the sequence of laser beam pulses, wherein the laser pulse source is mounted to a movable stage; and
controlling positioning of the movable stage during scanning of the sequence of laser beam pulses to the focal positions in the ophthalmic lens.

13. A method of coordinating control power and scanning of a sequence of laser beam pulses to focal positions in an ophthalmic lens to form a subsurface optical structure in the ophthalmic lens, the method comprising:
loading an ordered list of pulse power data values for the sequence of laser beam pulses on a memory accessible by a power-control computing device, wherein the ordered list of pulse power data values is indicative of pulse powers for the sequence of laser beam pulses;
loading a scanning control program into a scanning-control computing device, wherein the scanning control program comprises instructions for generating scanning control commands to control a scanning assembly to direct the sequence of laser beam pulses to the focal positions in the ophthalmic lens;
controlling a power control assembly by the power-control computing device to cause a first laser beam pulse of the sequence of laser beam pulses to have a first pulse power corresponding to a first pulse power data value of the ordered list of pulse power data values;
controlling a scanning assembly by the scanning-control computing device to direct the first laser beam pulse to a first focal position of the focal positions in the ophthalmic lens;
sending a first trigger signal to the power-control computing device, wherein receipt of the first trigger signal by the power-control computing device causes the power-control computing device to control the power control assembly to cause a second laser beam pulse of the sequence of laser beam pulses to have a second pulse power corresponding to a second pulse power data value of the ordered list of pulse power data values for the sequence of laser beam pulses; and
controlling the scanning assembly by the scanning-control computing device to direct the second laser beam pulse to a second focal position of the focal positions in the ophthalmic lens.

14. (canceled)

15. The method of claim 13, wherein the scanning-control computing device comprises a programmable scanning controller.

16. The method of claim 13, wherein the first trigger signal is generated by the scanning-control computing device, and wherein the scanning control program controls transmission of the first trigger signal by the scanning-control computing device.

17. The method of claim 16, wherein the scanning control program specifies when a new pulse power data value of the ordered list of pulse power data values is needed, and wherein the second pulse power data value is next in sequence to the first pulse power data value on the ordered list of pulse power data values.

18. The method of claim 13, wherein the power control assembly comprises an acousto-optic modulator or an electro-optic modulator.

19. (canceled)

20. The method of claim 13, further comprising:
receiving data defining the subsurface optical structure; and
generating the scanning control program based on the data defining the subsurface optical structure.

21. The method of claim 13, further comprising:
sending a second trigger signal to cause the power-control computing device to fetch a third pulse power data value; and
controlling, by the power-control computing device, the power control assembly to cause a laser beam pulse of the sequence of laser beam pulses to have a third pulse power level.

22. The method of claim 13, wherein:
the scanning assembly comprises one or more laser galvos and a depth of focus mechanism;
the one or more laser galvos are operable to control direction for each of the sequence of laser beam pulses in two directions transverse to a direction of propagation of the sequence of laser beam pulses; and
the depth of focus mechanism is operable to control depth of focus for each of the sequence of laser beam pulses in the direction of propagation of the sequence of laser beam pulses.

23. The method of claim 13, wherein the ophthalmic lens is disposed on a movable stage, and further comprises controlling, by the scanning-control computing device, positioning of the movable stage during the scanning of the sequence of laser beam pulses to the focal positions in the ophthalmic lens.

24. The method of claim 13, wherein a laser pulse source from which the sequence of laser beam pulses is emitted is disposed on a movable stage, and further comprises controlling, by the scanning-control computing device, positioning of the movable stage during the scanning of the sequence of laser beam pulses to the focal positions in the ophthalmic lens.

25.-39. (canceled)
